(19) United States
(12) Patent Application Publication
(10) Pub. No.: US 2013/0110533 A1
(43) Pub. Date: May 2, 2013

(54) SYSTEMS AND METHODS FOR MANAGING BILLING BETWEEN ONE OR MORE HEALTHCARE PROVIDERS OR THEIR ASSIGNEE AND ONE OR MORE PAYERS FOR SERVICES PROVIDED BY THE ONE OR MORE PROVIDERS WITHIN TEMPORARY ARRANGEMENTS

(71) Applicant: LOCUMSMART, LLC, Norcorss, GA (US)

(72) Inventors: Geoffrey Aaron Paul, Mexico, D.F., MX (US); Robert Baxter Shumard, Dunwoody, GA (US)

(73) Assignee: LOCUMSMART, LLC, Norcorss, GA (US)

(21) Appl. No.: 13/660,757

(22) Filed: Oct. 25, 2012

Related U.S. Application Data
(60) Provisional application No. 61/551,476, filed on Oct. 26, 2011.

(51) Int. Cl. G06F 19/00

(52) U.S. Cl. CPC G06F 19/328
USPC 705/2

(57) ABSTRACT

Computing systems, including web-based systems, and methods for managing billing between (i) one or more healthcare providers or their assignee and (ii) one or more payers for the services provided by the one or more providers within a temporary service arrangement are disclosed.

### RELATED APPLICATIONS

The present application claims priority to U.S. Provisional Application No. 61/551,476, filed on Oct. 26, 2011, and entitled SYSTEMS AND METHODS FOR MANAGING BILLING BETWEEN ONE OR MORE HEALTHCARE PROVIDERS OR THEIR ASSIGNEE AND ONE OR MORE PAYERS FOR SERVICES PROVIDED BY THE ONE OR MORE PROVIDERS WITHIN TEMPORARY ARRANGEMENTS, which is incorporated by reference herein in its entirety.

### TECHNICAL FIELD

The present invention relates to methods and computing systems including web-based systems for managing billing between one or more healthcare providers or their assignee and one or more payers for the services provided by the one or more providers within a temporary service arrangement.

### BACKGROUND

A system and method for matching healthcare providers with healthcare organizations on a temporary basis, as well as a system and method for managing aspects of such a temporary/supplemental staffing relationship is disclosed in U.S. patent application Ser. No. 12/873,699, entitled “AUTOMATED SYSTEMS AND METHODS FOR MATCHING HEALTHCARE PROFESSIONALS WITH HEALTHCARE ORGANIZATIONS ON A TEMPORARY BASIS”, filed on Sep. 1, 2010, and being invented by the inventor of the present application, the subject matter of which is incorporated by reference herein in its entirety (hereinafter, “the '699 application”).

In locum tenens arrangements, particularly those that do not meet the strict definition of a locum tenens such as where the temporary healthcare provider is a non-replacement provider who is adding to the number of providers of a given healthcare organization rather than acting in a substitute capacity, healthcare organizations typically bill for Part A claims (i.e., costs relating to the use of a given facility such as a hospital). Such costs are typically paid by a payment authority such as the government (i.e., Medicare/Medicaid), a commercial insurance company (e.g., Kaiser, Blue Cross Blue Shield (BCBS), etc.), and/or an individual receiving the service provided by the healthcare organizations. However, healthcare organizations often do not bill Part B claims (i.e., costs relating to the professional fees of the healthcare provider). Healthcare organizations typically do not bill Part B claims because in order to bill Part B (i.e., professional fees) for a healthcare provider's services, the healthcare organization and healthcare provider must meet the following conditions:

the healthcare provider must assignee his/her rights to the Part B charges to the healthcare organization (HCO) having the facility at which the provider is providing services;
the group/practice/HCO must be enrolled with, and have a Medicare/Medicaid number;

the group/practice must have a re-imbursement contract with the proper Part B payers (e.g., (i) the government, for example, the Centers for Medicare and Medicaid Services (CMS), which is a federal agency, and/or (ii) a commercial payer, for example, insurance companies such as Kaiser, BCBS, etc.);
the healthcare provider must be enrolled with, and have a Medicare/Medicaid number;

the healthcare provider must be enrolled with any applicable commercial payers;

the healthcare provider must be a member of a group with Medicare/Medicaid (e.g., a HCO) and have extended privileges from the group; and

the healthcare provider must be a member of the group with Medicare/Medicaid with approval to bill for services performed at a particular facility (i.e. the healthcare provider must apply to Medicare/Medicaid asking them to add his/her provider number to a given group).

In addition, other typical reasons that healthcare organizations (HCOs) do not bill Medicare/Medicaid Part B include, but are not limited to:

the HCO does not employ any physicians, and therefore only has Part A (i.e., facility fees) contracts (Note: This is the standard model, and involves private groups/practices providing Part B services at a hospital. The group/practice bills Part B, and the hospital bills Part A. Oftentimes the reason a locum is needed is because a physician in a small community won't be working for a while (i.e., vacation, CME, etc.) and the hospital cannot afford to lose out on the revenue that the doctor normally provides, so they will encourage the doctor to hire a locum to cover his/her practice. While in this case, the locum tenens provider may meet the strict definition of a locum tenens and therefore may qualify for a Q6 modifier exception to some of the above requirements.);

creating a medical group, and then getting Part B contracts for that group is too time-consuming and expensive to be worth it for the charges generated by one assignment;

many states prohibit “fee-splitting” between medical groups and HCOs, precluding the HCO from offering to split the costs of a locum with a group in exchange for splitting the collections;

the HCO owns a medical group/practice that has Part B payer contracts, but doesn't enroll the physician into the group/practice prior to the start of the assignment;

standard credentialing time for enrollment into the group/practice is longer than time remaining before the start of the assignment (e.g., credentialing time may be 9 months whereas the assignment may start in 2.5 weeks);

the billing department and staffing department of the HCO often do not talk to each other, and the billing department may not be aware that a locum is at the facility until claims generated by the locums' professional activities arrive at the billing office to be processed;

if it takes 30 days for the provider's first claims to reach the billing department, it is likely the assignment is already over as the average locums assignment is only 30 days, and therefore any efforts to enroll will be futile;

the efforts necessary to enroll the provider (both in terms of money and time) are perceived to be greater than the Part B charges that potentially could be collected;

hospitals often do not even consider trying to enroll a provider unless the locum will be needed for greater than a year; and

the majority of temporary staffing that takes place at healthcare organizations and is commonly referred to as “locum tenens” does not fit the CMS definition of locum tenens due to reasons discussed above such as being a non-replacement temporary provider who adds to the total number of providers of the organization rather than being a substitute for an absent permanently employed physician and therefore cannot be billed using the Q6 modifier, but must be billed using the same processes as permanent, employed medical staff at the HCO.

What is needed in the art is a system and method for managing billing between (i) one or more healthcare providers or their assignee and (ii) one or more payers for the services provided by the one or more providers within a temporary service arrangement, particularly a non-replacement temporary service arrangement.

### SUMMARY

The embodiments of the present invention address the need for systems and methods for managing billing between (i) one or more healthcare providers or their assignee and (ii) one or more payers for the services provided by the one or more providers within a temporary service arrangement, particularly a non-replacement temporary service arrangement. The embodiments of systems and methods of the present invention enable efficient, cost-effective billing of at least Medicare/Medicaid component Part B between (i) one or more healthcare providers or their assignee and (ii) one or more payers for the services provided by the one or more providers within a temporary service arrangement, while providing a clear, transparent record of the business relationships therebetween.

The present invention provides a system and method for managing billing between (i) one or more healthcare providers or their assignee and (ii) one or more payers for the services provided by the one or more providers within a temporary service arrangement by creating a national medical group which may be partially owned by a management company and further owned by all participating healthcare organizations. The medical group contracts with Part B payers, and enrolls all locum tenens (e.g., non-replacement temporary healthcare providers) for the medical group which covers all participating HCOs the first time the healthcare provider fills a temporary assignment at a participating HCO. The medical group also seeks approval for billing for work done by the non-replacement temporary healthcare provider at a particular facility of an HCO at the but at the time of this initial assignment may also seek approval for billing for work that may be done by the non-replacement temporary healthcare provider at all facilities of all HCOs of the medical group. The management company then bills Part B for the locums' services on behalf of the medical group and pays the HCO who has the facility where the work was done a percentage of collections.

The disclosed model solves the above-described problem of HCOs not billing Part B payers by one or more of the following:

the medical group provides access to Part B payer contracts to HCOs that have none;

because credentialing and enrollment data is stored in an online database (e.g., via LocumsMart), all participating HCOs within the medical group will have access to real-time information regarding their ability to credential a physician for a given facility Currently, a lot of the cost in the system comes from the fact that all assignments are “pending credentialing.” Ordinarily, when HCOs receive “bids” of available temporary candidates from staffing agencies, the HCO does not know whether the HCO will be able to enroll the physician and bill for their services. Both the agency and the HCO incur up-front costs, which are a total loss if the physician is rejected during the credentialing process and the search must be re-started. The medical group can “flag” providers in the LocumsMart database so that when a participating HCO receives a bid, the HCO knows up-front whether the provider is already enrolled with the group (i.e., guaranteeing that the HCO will be able to collect Part B charges), or has previously been rejected at another facility where the group has privileges), resulting in better providers and better patient outcomes.);

reduces overall healthcare delivery system costs (e.g., saves money for HCOs);

because the medical group is owned by the participating HCOs, (i) monies paid to the HCOs from the group are profit distributions rather than fee splits, (ii) upon request by the HCO, a provider can be enrolled in the group and even approved for billing at all facilities where the group provides services at the same time as the provider is credentialed and enrolled with approval for billing at a single facility, and (iii) certain contractual efficiencies may be realized.

Accordingly, the present invention is directed to methods of managing billing between (i) one or more healthcare providers or their assignee and (ii) one or more payers for the services provided by the one or more providers within a temporary service arrangement. In one exemplary embodiment, the method for managing billing between (i) one or more healthcare providers or their assignee and (ii) one or more payers for the services provided by the one or more providers within a temporary service arrangement comprises: in response to a healthcare provider completing a provider billing assignment agreement with the healthcare organization, billing of Medicare/Medicaid Part B by a locums tenens vendor billing service.

In another exemplary embodiment, the method for managing billing between (i) one or more healthcare providers or their assignee and (ii) one or more payers for the services provided by the one or more providers within a temporary service arrangement comprises: in response to a healthcare provider completing a provider billing assignment agreement with the healthcare organization, billing of Medicare/Medicaid Parts A and B by a locums tenens vendor billing service.

In yet another exemplary embodiment, the method for managing billing between (i) one or more healthcare providers or their assignee and (ii) one or more payers for the services provided by the one or more providers within a temporary service arrangement comprises a method for matching a healthcare professional (e.g., provider) with a healthcare organization on a temporary basis, wherein the method comprises: creating a service assignment for temporary healthcare provider services using a secure web-based system; submitting the service assignment along with a request to bid on the service assignment to one or more potential bidders via the secure web-based system; in response to receiving one or more bids from the one or more potential bidders for the service assignment via the secure web-based system, accepting a bid for the service assignment via the secure web-based system, wherein the accepting step creates an electronic confirmation agreement that is made a part of and governed under terms of a master agreement between the healthcare organization and a winning bidder; and providing notification of acceptance to the winning bidder for an accepted bid via the secure web-based system; wherein a component of the master agreement between the healthcare organization and the winning bidder comprises a provider billing assignment agreement in which the provider assigns his/her billings for services provided during the temporary service assignment to the healthcare organization.

The present invention is further directed to computing systems capable of performing the disclosed methods for managing billing between (i) one or more healthcare providers or their assignee and (ii) one or more payers for the services provided by the one or more providers within a temporary service arrangement. Typically, a given computing system comprises at least one application module usable on the computing system, wherein the at least one application module comprises application code loaded thereon for performing one or more of the disclosed methods for managing billing between (i) one or more healthcare providers or their assignee and (ii) one or more payers for the services provided by the one or more providers within a temporary service arrangement.

The present invention is even further directed to computing systems comprising at least one device operatively adapted to access a secure web-based system and utilize one or more of the disclosed methods for managing billing between (i) one or more healthcare providers or their assignee and (ii) one or more payers for the services provided by the one or more providers within a temporary service arrangement. Desirably, a given computing system comprises at least one device operatively adapted to access the secure web-based system and utilize one or more of the disclosed methods for managing billing between (i) one or more healthcare providers or their assignee and (ii) one or more payers for the services provided by the one or more providers within a temporary service arrangement.

More specifically, embodiments are directed to a method of billing for work done by non-replacement temporary healthcare providers that have assigned their rights to collect on the billing. The method involves receiving at a computing system electronic information about a healthcare group that utilizes the non-replacement temporary healthcare providers, the information about the healthcare group being necessary for billing for work done on behalf of the healthcare group with a payment authority. The method further involves receiving at the computing system electronic information about a non-replacement temporary healthcare provider necessary for enrollment to bill for work to be done by the non-replacement temporary healthcare provider with the payment authority. Additionally, the method involves receiving at the computing system electronic information regarding the work done by the non-replacement temporary healthcare provider on behalf of the healthcare group. The method also involves generating at the computing system electronic billing information for submission to the payment authority, the electronic billing information comprising at least some of the electronic information received about the healthcare group and at least some of the electronic information received about the non-replacement temporary healthcare provider.

Embodiments are further directed to a method of billing for work done by non-replacement temporary healthcare providers for individual healthcare organizations, wherein a healthcare group comprises a plurality of the individual healthcare organizations who have contracted for combined ownership of the healthcare group without fee splitting. The method involves enrolling the healthcare group with a payment authority responsible for paying for the work done by the non-replacement temporary healthcare providers and enrolling a non-replacement temporary healthcare provider with the payment authority. The method further involves at a computing system, accessing a facility identifier for a facility of an individual healthcare organization where the non-replacement temporary healthcare provider will complete the work and requesting an approval of the facility identifier from the payment authority for the healthcare group. Additionally, the method involves receiving at the computing system electronic information regarding the work done by the non-replacement temporary healthcare provider on behalf of the healthcare group at the facility of the individual healthcare organization. The method also involves at the computing system, generating billing information for submission to the payment authority, the billing information comprising the information regarding the work done, information identifying the enrollment of the healthcare group, information identifying the enrollment of the non-replacement temporary provider, and the facility identifier.

Additionally, embodiments are directed to a computing system that includes a database storing information that associates a healthcare group with non-replacement temporary healthcare providers, and associates facility identifiers to individual non-replacement temporary healthcare providers to identify the facilities for which a non-replacement temporary healthcare provider is approved for billing on behalf of the healthcare group to a payment authority, where the facilities are owned by individual healthcare organizations who share ownership of the healthcare group without fee splitting. The computing system further includes a module that is configured to receive electronic information about the non-replacement temporary healthcare providers and store the electronic information to the database and obtain from the database a non-replacement temporary healthcare provider to work at a facility of a healthcare organization who shares ownership of the healthcare group. The module is further configured to detect from the database whether the non-replacement temporary healthcare provider is approved for billing the payment authority for work done at the facility of the healthcare organization. When the non-replacement temporary healthcare provider is not approved for the facility, the module is configured to then generate information for submission to the payment authority that requests approval for billing for the work of the non-replacement temporary healthcare provider on behalf of the healthcare group at the facility of the healthcare organization.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a schematic of exemplary participants utilizing the secure web-based systems and methods of the present invention for managing billing between (i) one or more healthcare providers or their assignee and (ii) one or more payers for the services provided by the one or more providers within a temporary service arrangement;

FIG. 2 depicts another schematic of exemplary participants utilizing the secure web-based systems and methods of the present invention for managing billing between (i) one or more healthcare providers or their assignee and (ii) one or more payers for the services provided by the one or more providers within a temporary service arrangement;

FIG. 3 depicts an exemplary locum tenens assignment form suitable for use in the present invention; and

FIG. 4 depicts a schematic of exemplary participants utilizing the secure web-based systems and methods of the present invention to access electronically stored data via one or more computing devices.

FIGS. 5A-C depict an operational flow of one or more modules of a computing system to manage the billing for work done by a non-replacement temporary healthcare provider on behalf of a healthcare organization who is a co-owner of a healthcare group enrolled with a payment authority.

FIG. 6 shows an example of a computing system that implements the logical operations of FIGS. 5A-C.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to methods of managing billing between (i) one or more healthcare providers or their assignee and (ii) one or more payers for the services provided by the one or more providers within a temporary service arrangement. The present invention is further directed to computing systems capable of performing the disclosed methods for managing billing between (i) one or more healthcare providers or their assignee and (ii) one or more payers for the services provided by the one or more providers within a temporary service arrangement. The present invention is even further directed to computing systems comprising at least one device operatively adapted to access a secure web-based system and utilize one or more of the disclosed methods for managing billing between (i) one or more healthcare providers or their assignee and (ii) one or more payers for the services provided by the one or more providers within a temporary service arrangement.

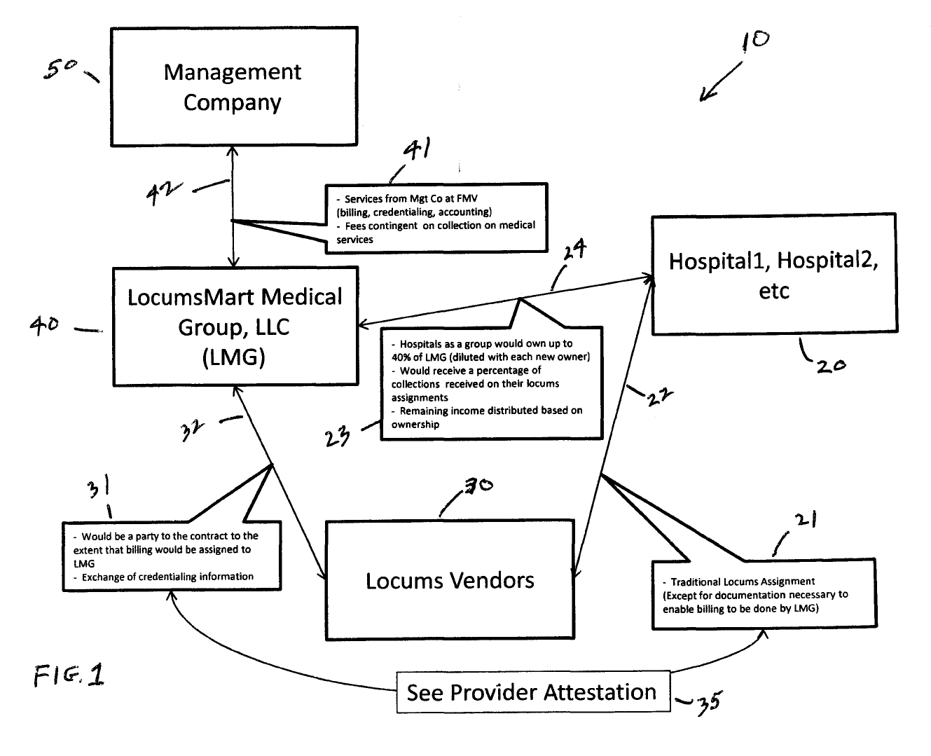

FIG. 1 depicts a schematic of exemplary participants utilizing the secure web-based systems and methods for managing billing between (i) one or more healthcare providers or their assignee and (ii) one or more payers for the services provided by the one or more providers within a temporary service arrangement. As shown in FIG. 1, exemplary system 10 comprises a national medical group 40 (shown as “LocumsMart Medical Group, LLC” and “LMG”), a management company (also referred to herein as “LocumsMart Billing Services, LLC” or “LMBS”) 50, one or more healthcare organizations (also referred to herein as one or more “HCO” or “HCOs”) 20, and locum tenens vendors 30. As shown in FIG. 1, system 10 enables a number of system features and tasks between the shown parties.

As shown in FIG. 1, (1) one or more locum tenens vendors 30 and one or more healthcare organizations (e.g., one or more hospitals) 20 perform a number of interactive tasks 22 with one another including, but not limited to, traditional locum tenens assignment functions (e.g., providing contract (i.e., not full-time employees) healthcare providers to a given hospital for a temporary assignment and/or period of time) as shown by box 21, especially a non-replacement temporary assignment where the healthcare provider does not qualify for a Q6 modifier; (2) one or more locum tenens vendors 30 and national medical group (LMG) 40 perform a number of interactive tasks 32 with one another including, but not limited to, exchanging information such as credentialing information to help facilitate service assignments of one or more healthcare providers, and acting as a liaison between national medical group (LMG) 40 and management company (LMBS) 50 as shown by box 31; (3) one or more healthcare organizations 20 and national medical group (LMG) 40 perform a number of interactive tasks 24 with one another including, but not limited to, distribution of income based on percent ownership and/or available funds after expenses as shown by box 23; and (4) national medical group (LMG) 40 and management company (LMBS) 50 perform a number of interactive tasks 42 with one another including, but not limited to, providing management services as shown by box 41.

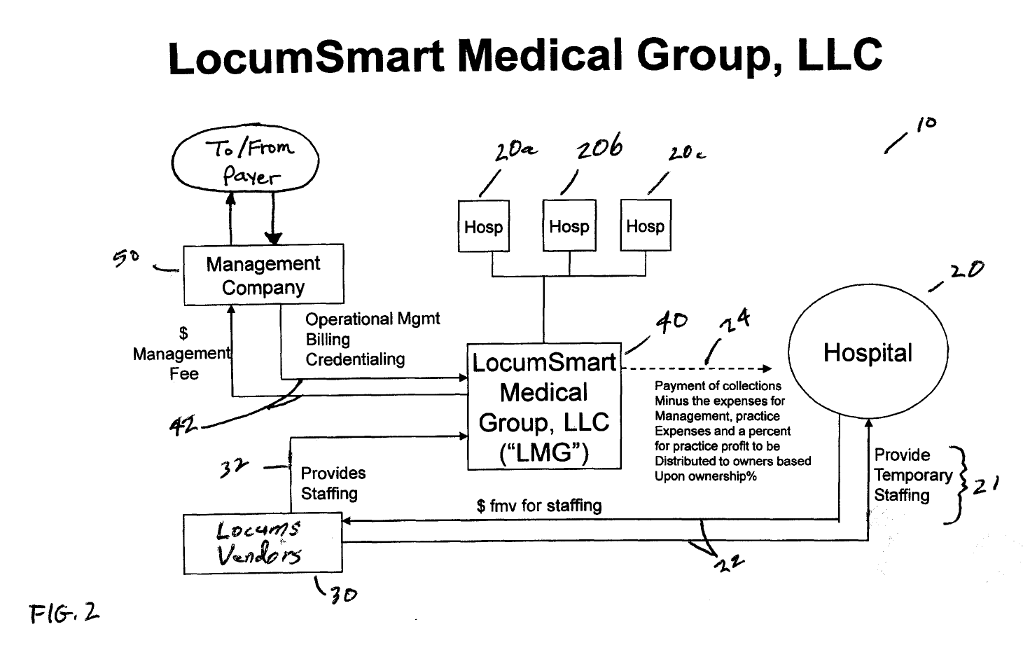

FIG. 2 depicts another schematic of exemplary participants utilizing secure web-based systems and methods of the present invention such as exemplary system 10 for managing billing between (i) one or more healthcare providers (e.g., providers 61, 62, 63) or their assignee and (ii) one or more payers (e.g., the government, a commercial entity, and/or an individual) for the services provided by the one or more providers within a temporary service arrangement.

As shown in FIG. 2, (1) one or more locum tenens vendors 30 and one or more healthcare organizations 20 (e.g., hospitals 20a, 20b and 20c) perform a number of interactive tasks 22 with one another including, but not limited to, providing healthcare providers (e.g., contract doctors, nurses, etc.) to a given hospital for a temporary assignment (as shown by task 21), and one or more healthcare organizations 20 paying locum tenens vendor 30 for temporary staffing services provided by one or more locum tenens vendors 30; (2) one or more locum tenens vendor 30 and national medical group 40 (“LMG”) perform a number of interactive tasks 32 with one another including, but not limited to, exchanging information, such as credentialing information, with regard to the temporary staffing provided by the one or more locum tenens vendors 30 to one or more healthcare organizations 20; (3) one or more healthcare organizations 20 and national medical group 40 perform a number of interactive tasks 24 with one another including, but not limited to, payment of collections minus expenses paid for management services of LMG, and payment of a proportion of LMG profits based on ownership interest (e.g., ownership interest of each individual healthcare organization 20 shown as 20a, 20b and 20c); and (4) national medical group 40 and management company 50 perform a number of interactive tasks 42 with one another including, but not limited to, providing management services to national medical group 40, and payment for management services provided by management company 50 (e.g., operational management services, billing services, and credentialing services).

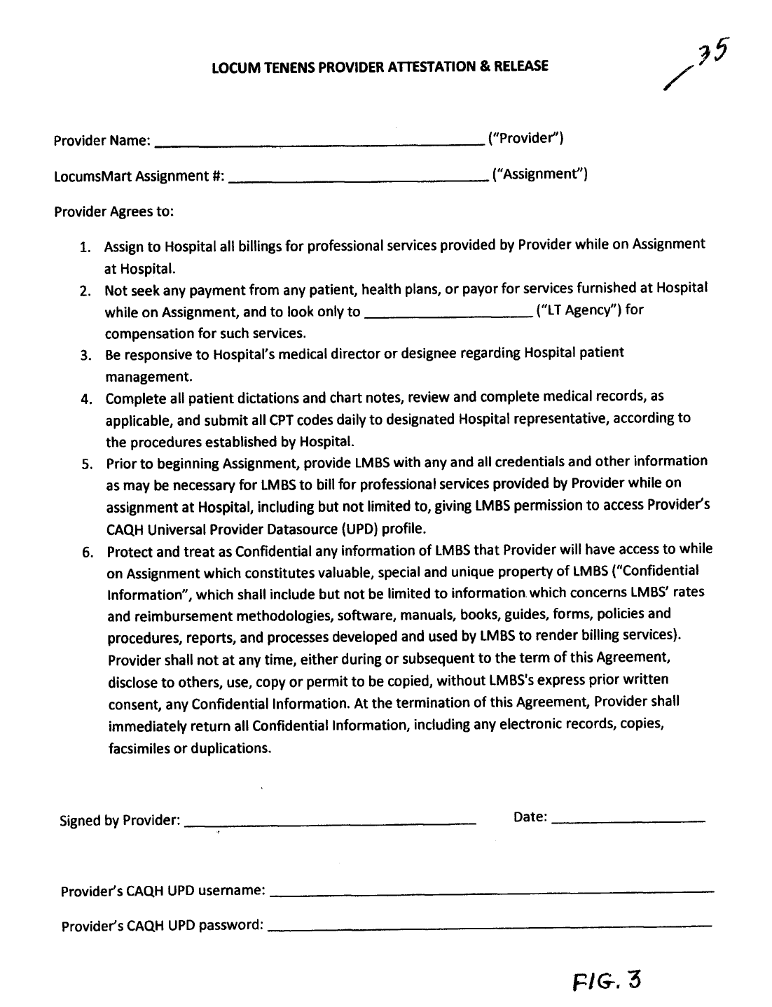

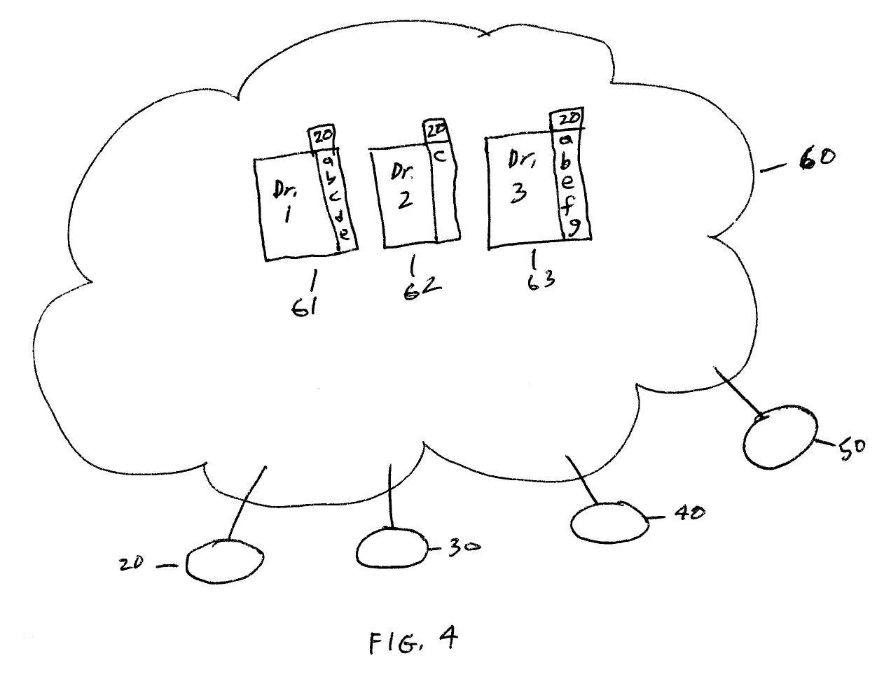

As shown in FIG. 1, system 10 also utilizes a provider billing assignment (shown as provider attestation form 35 and referred to herein as a “Locum Tenens Provider Attestation & Release” form), wherein a service provider (e.g., a doctor) assigns his/her billings for professional services to a given hospital/HCO. An exemplary provider billing assignment form suitable for use in the present invention is shown in FIG. 3.

As shown in FIG. 3, exemplary provider billing assignment form 35 states that the service provider (e.g., a doctor) agrees to:

1. assign to the hospital/HCO (e.g., hospital 20c) all billings for professional services provided by the service provider while on assignment at the hospital (e.g., hospital 20c);

2. not seek payment from any patient, health plans, or payor for services furnished at the hospital/HCO (e.g., hospital 20c) while on assignment, and to look only to a locum tenens vendor/agency (e.g., locum tenens vendor 30) (“LT Agency”) for compensation for such services;

3. be responsive to the hospital's (e.g., hospital 20c) medical director or designee regarding the hospital (e.g., hospital 20c) patient management;

4. complete all patient dictations and chart notes, review and complete medical records, as applicable, and submit all CPT codes daily to designated hospital (e.g., hospital 20c) representative, according to the procedures established by the hospital (e.g., hospital 20c);

5. prior to beginning a given assignment, provide the management company (e.g., management company 50) (“LMBS”) with any and all credentials and other information as may be necessary for LMBS to bill for professional services provided by the provider while on assignment at the hospital (e.g., hospital 20c), including but not limited to, giving LMBS permission to access the provider's CAQH Universal Provider Datasource (UPD) profile (typically stored electronically as discussed below); and

6. protect and treat as Confidential any information of LMBS that the provider will have access to while on assignment which constitutes valuable, special and unique property of LMBS (“Confidential Information”, which shall include but not be limited to information which concerns LMBS' rates and reimbursement methodologies, software, manuals, books, guides, forms, policies and procedures, reports, and processes developed and used by LMBS to render billing services). The provider shall not at any time, either during or subsequent to the term of the billing assignment agreement, disclose to others, use, copy or permit to be copied, without LMBS's express prior written consent, any Confidential Information. At the termination of the billing assignment agreement, the provider shall immediately return all Confidential Information, including any electronic records, copies, facsimiles or duplications to the locum tenens vendor/agency (e.g., locum tenens vendor 30).

FIG. 4 depicts a schematic of exemplary participants utilizing the secure web-based systems and methods of the present invention to access electronically stored data via one or more computing devices. As shown in FIG. 4, the computing systems of one or more healthcare organizations 20, one of more locums vendors 30, medical group 40, and management company 50 have secure access to electronically stored data 60 within a database, where this access may be via any type of computing device (or any Internet-accessing device) such as personal computers, server computers, smartphones, tablets, and the like. Electronically stored data 60 may include, but is not limited to, credential records of individual healthcare providers such as exemplary credential records 61, 62 and 63 of individual healthcare providers “Dr. 1”, “Dr. 2” and “Dr. 3” respectively. Credential records for a given individual healthcare provider may include, but is not limited to, the provider's curriculum vitae (CV), references, copies of certifications and licenses, employment eligibility verification, history of accepted and/or declined bids (if any) and reasons for the decline, history of past and current assignments to other healthcare organizations 20, etc.

As shown in FIG. 4, exemplary credential record 61 of individual healthcare provider “Dr. 1” may provide details of past service assignments performed at hospitals 20a, 20b, 20c, 20d and 20e, while exemplary credential record 62 of individual healthcare provider “Dr. 2” may provide details of past service assignments performed at only hospital 20c. The credential records 61, 62, 63 may set forth an identification of the particular facilities of the HCOs where the health care provider is already approved for billing purposes which allows the HCO to make an informed selection of a healthcare provider from the database 60 to hire for the temporary service assignment. Furthermore, each doctor (e.g., “Dr. 1”, “Dr. 2”, etc.) may have worked service assignments at multiple HCOs through multiple vendors (i.e. “Dr. 1” may have worked at hospital 20a through locums tenens vendor A, but may have worked at hospital 20b through locums tenens vendor B, but “Dr. 2” may have worked at hospital 20b through locums tenens vendor C. Exemplary credential record 61 of individual healthcare provider “Dr. 1”, for example, may provide such details of past service assignments with multiple locums vendors 30.

Although not shown in FIG. 4, electronically stored data 60 may also include, but is not limited to, names and contact information for representatives of each healthcare organization 20, locums vendor 30, medical group 40 and management company 50; copies of billing and accounting records showing billings/accounting between each of healthcare organization 20, locums vendor 30, medical group 40 and management company 50; real-time percent ownership of medical group 40 by each healthcare organization 20; and copies of signed contracts between each of healthcare organization 20, locums vendor 30, medical group 40 and management company 50 (e.g., copies of billing assignment agreements between individual healthcare providers and a given healthcare organization 20 (i.e., electronic copies of signed provider attestation forms 35 shown in FIG. 3).

As shown in FIGS. 1-4, the systems and methods of the present invention may comprise various participants and method steps. In addition to the above-mentioned method steps, the methods of the present invention may comprise one or more of the following steps:

forming a national medical group 40 owned by a management company 50 and all healthcare organizations 20 doing locum tenens business with national medical group 40, wherein the national medical group 40 (LMG) provides services to facilitate exchange of information between one or more locum tenens agencies 30 and one or more participating healthcare organizations 20;

forming a national medical group 40 wherein a percent ownership of national medical group 40 is held by each individual healthcare organization 20 doing locum tenens business with national medical group 40;

reimbursement to each individual healthcare organization (HCO) 20 based on the amount of locum tenens business performed at each individual healthcare organization 20 via national medical group 40 and locum tenens agency 30;

assigning a provider's billing to one or more healthcare organization 20 via a contractual relationship;

exchanging credentialing information between locum tenens agency 30 and national medical group 40;

in addition to executing the locum tenens service assignment service agreement (i.e., master agreement) as disclosed and described in the '699 application, executing a locum tenens provider billing assignment (i.e., provider attestation form 35 or “Locum Tenens Provider Attestation & Release” form) so as to enable assignment of a service provider's billings for professional services (e.g., a doctor's billings) to a given individual healthcare organization 20;

in response to execution of a provider billing assignment (i.e., provider attestation form 35 or “Locum Tenens Provider Attestation & Release” form) by a healthcare provider, billing Medicare Part B alone or in combination with Medicare Part A;

controlling access to confidential information stored electronically on a secure web-based system, the controlling being done by locum tenens agency 30 and/or national medical group 40;

national medical group 40 contracting with Part B payers;

enrolling all locum tenens healthcare providers at all facilities of all participating HCOs (e.g., hospitals 20a, 20b, etc.) the first time the locum tenens healthcare provider fills out a locum tenens assignment agreement;

management company 50 billing Part B for the locum tenen healthcare provider's services and paying the HCO a percentage of collections;

national medical group 40 paying management company 50 a management fee contingent on collection of money for medical services for a given locum tenens assignment;

in response to execution of a provider billing assignment (i.e., provider attestation form 35 or “Locum Tenens Provider Attestation & Release” form) by a healthcare provider and completion of a given service assignment at a facility of the contracting individual healthcare organization 20 (e.g., hospital 20a), billing of Medicare Parts A and B by the management company 50 (e.g., LMBS);

The present invention is further directed to computing systems capable of performing the disclosed methods for managing billing between (i) one or more healthcare providers or their assignee and (ii) one or more payers for the services provided by the one or more providers within a temporary service arrangement. Typically, a given computing system comprises at least one application or program usable on the computing system, wherein the at least one application or program comprises application code loaded thereon for performing one or more of the disclosed methods for managing billing between (i) one or more healthcare providers or their assignee and (ii) one or more payers for the services provided by the one or more providers within a temporary service arrangement. For example, a server may be used to run application code for performing one or more of the disclosed methods for managing billing between (i) one or more healthcare providers or their assignee and (ii) one or more payers for the services provided by the one or more providers within a locum tenens service arrangement with the server being connected to a computing system that is accessible from a variety of devices (e.g., computers, hand-held computers, phones, PDAs, music players, notepads, notebooks, etc.; also, see below).

The present invention is even further directed to computing systems comprising at least one device operatively adapted to access a secure web-based system and utilize one or more of the disclosed methods for managing billing between (i) one or more healthcare providers or their assignee and (ii) one or more payers for the services provided by the one or more providers within a temporary service arrangement. Desirably, a given computing system comprises at least one device operatively adapted to access the secure web-based system and utilize one or more of the disclosed methods for managing billing between (i) one or more healthcare providers or their assignee and (ii) one or more payers for the services provided by the one or more providers within a temporary service arrangement so as to facilitate efficient, cost-saving procedures in a locum tenens setting.

A variety of devices may be used to access a secure web-based system and utilize one or more of the disclosed methods for managing billing between (i) one or more healthcare providers or their assignee and (ii) one or more payers for the services provided by the one or more providers within a temporary service arrangement. Suitable devices include, but are not limited to, personal computers, server computers, hand-held or laptop devices (e.g., computers, smart phones, notepads, or any other device with Internet access), multiprocessor systems, microprocessor-based systems, set top boxes, programmable consumer electronics, network PCs, minicomputers, mainframe computers, distributed computing environments that include any of the above systems or devices, and the like.

The systems and methods of the present invention enable the efficient, cost-effective managing of billing between (i) one or more healthcare providers or their assignee and (ii) one or more payers for the services provided by the one or more providers within a temporary service arrangement while providing a clear, transparent record of the business relationship therebetween. The systems and methods of the present invention provide the following benefits over prior methods of managing billing:

eliminates the need for the HCO to have contracts with Part B payers in order to bill for services provided by a locum tenens 30 at that HCO 20;

the ability to lower overall costs for the HCOs due to them now receiving re-imbursement for the professional services (Part B) provided by locum tenens provider(s) while on service assignment(s) within a facility owned by the HCO, whereas previously they were paying for the services of the provider, but not receiving reimbursement for those services;

reduced labor expenses due to a decrease in the amount of time the healthcare organizations' employees spend on billing for services provided by locum tenens providers;

increased transparency, and access to data, should help healthcare organizations reduce costs through the establishment of best practices with regards to locum tenens staffing;

increased access to objective and transparent data, the ability to calculate ROI, and the adoption of enhanced best practices across a healthcare system—not to mention a less labor-intensive process;

reducing the time-intensive and laborious workflow steps relating to the contracting process between payers and healthcare organizations;

bring transparency where it lacked due to prior methods utilizing phone and paper-driven processes;

the ability to run quick, accurate reports with objective data with regards to Part B charges generated, and actual collections from those charges, for both past and current locum tenens assignments;

the ability to have billing assignment contracts signed on a “corporate” level so as to apply to all locum tenens assignments that occur at facilities within a healthcare organization's system;

the ability to reduce paperwork and associated labor costs for all parties;

the ability to greatly improve the transparency of the process due to the increased ease of reporting data off of digital documents instead of paper;

the ability to increase transparency and data reporting, which allows healthcare organizations to determine best practices and make locum tenens purchases with accurate ROI predictions; and

the ability for HCO to provide higher quality of care to the community due to the ability to bring in a locum tenens for staffing gaps that they previously couldn't afford to fill with a locum due to the high cost of locum tenens staffing, and the inability to collect re-imbursement on the charges generated by the locum while on assignment.

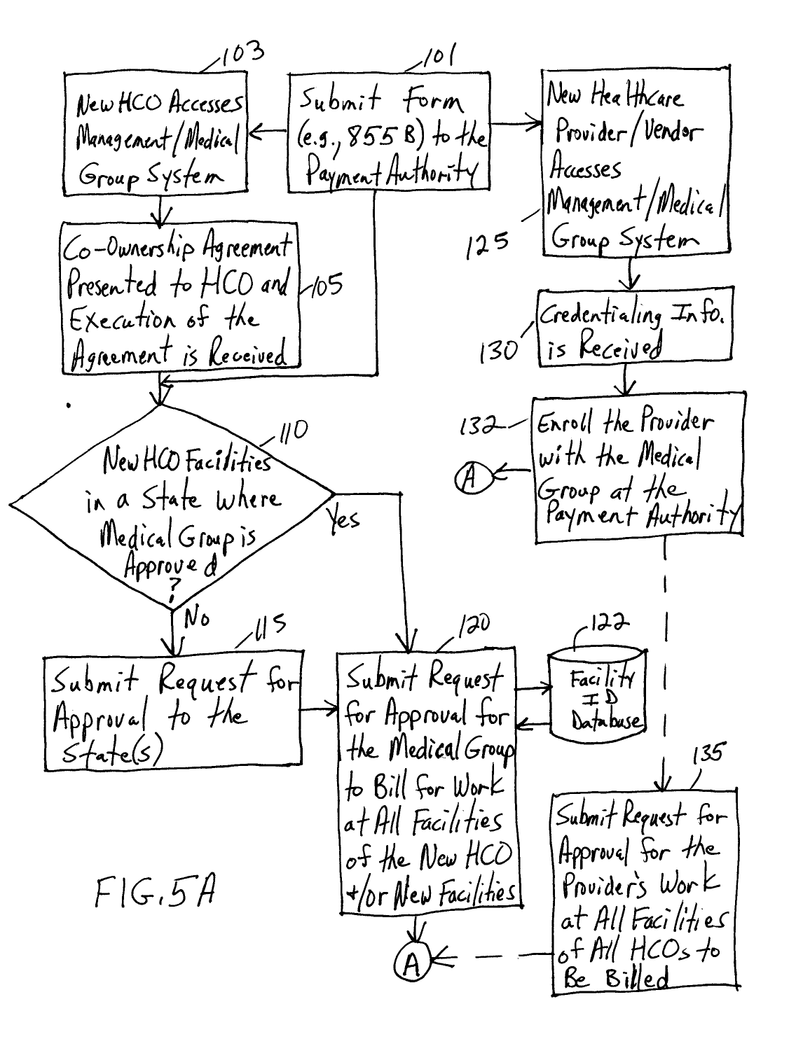

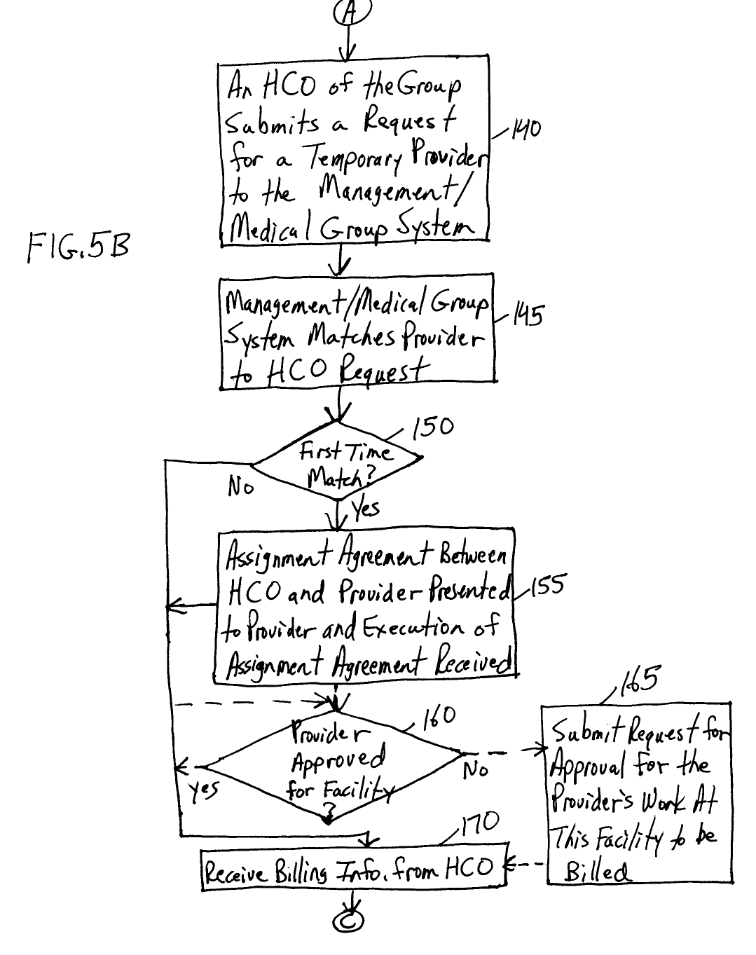

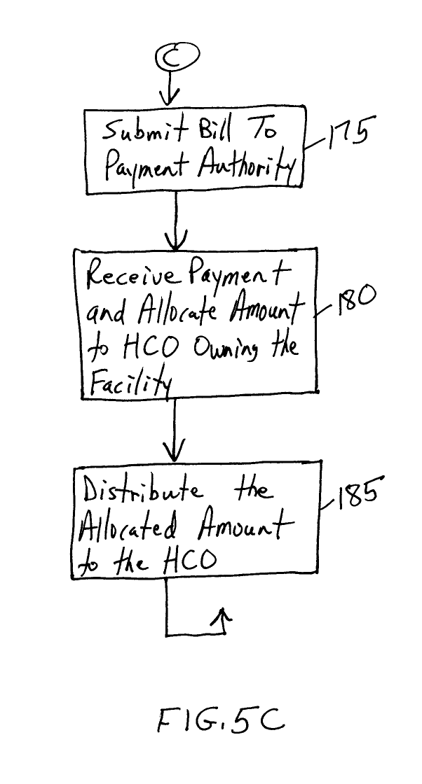

FIGS. 5A-C show one example of an operational flow that may occur according to the various embodiments disclosed herein for interaction between the computing systems of the various parties including the payment authority, the management company 50, the medical group 40, the healthcare organizations 20, and the healthcare providers either directly or through locums vendors 30.

Initially, the medical group 40 is formally created and enrolled as a medical group with the payment authority, such as by submitting a form 855B with CMS, at a submission operation 101. The submission may be done electronically via a module of a computing system of the management company 50 or that of the medical group 40. At this submission operation 101, the computing system obtains the necessary information about the medical group for purposes of submitting the relevant forms and other information to the payment authority, such as a medical group number. This initial submission may be for a medical group 40 having one or more HCOs 20. At this time, the medical group 40 may then enroll each facility of each of the member HCOs, which is discussed further below with respect to a request operation 120. While the preceding description is generally true for receiving a Medicare group number, Medicaid may call for an adjusted procedure whereby each provider is given a number unique to that provider and to the facility where the work is performed, as discussed below.

At some time after the enrollment of the medical group 40 with the payment authority, new HCOs may join the medical group. This is reflected in access operation 103 where a new HCO accesses the computing system responsible for receiving requests by HCOs to join the medical group. This may be a computing system of the management company 50 managing the medical group 40 or may be a computing system of the medical group 40. The HCO may access the computing system such as through a web-based interface providing remote access or through other computer-to-computer interaction.

The computing system gathers information at the access operation 103 necessary to join the HCO into the medical group, including information about the facilities that the HCO operates which will utilize the temporary healthcare providers offered to the medical group 40.

The computing system then presents a co-ownership agreement to the HCO at a presentation operation 105. The HCO then executes the co-ownership agreement which is received by the computing system. For instance, the HCO may electronically sign the co-ownership agreement or otherwise submit an electronic copy of the signed co-ownership agreement to the computing system.

The computing system may then determine from the new HCO enrollment information, or from a request directly from an existing HCO, whether the new or existing HCO has facilities that are outside of the states where the medical group 40 is currently approved at a query operation 110. Where the new facilities of the new or existing HCO are outside of the approved states, the computing system then submits a request for approval of the medical group to bill for healthcare services rendered in the state(s) of interest at a request operation 115.

In this illustrative embodiment, once the computing system has confirmed that the medical group is approved for providing services in the state(s) of interest for the new facilities, the computing system then seeks approval for the medical group to bill for services at those facilities at the request operation 120. Here the computing system may perform a look-up of the facilities within a facility ID database 122, such as the NPI# database for Medicare related facility IDs, to find the facility IDs for the new facilities to be approved. The computing system then generates the approval request for each of the facility IDs that have been obtained for submission to the payment authority. The submission may be by electronic communication or otherwise. This illustrative example of the operational flow demonstrates handling of the HCO-temporary provider relationship by the medical group 40 in FIG. 5B which is discussed further below.

As further illustrated in FIG. 5A, upon the formation of the medical group via the submission operation 103, healthcare providers or healthcare provider vendors 30 may access the computing system for purposes of offering services to the HCOs of the medical group. The new healthcare provider or vendor 30 accesses the computing system at an access operation 125, in much the same manner that a new HCO accesses the computing system. The computing system then receives the credentialing information of the healthcare provider at a credentialing operation 130.

Where necessary for the payment authority, the computing system may then generate a request to enroll the provider with the medical group at the payment authority at an enrollment operation 132. The computing system may generate the enrollment request based on the credentialing information that has been received and based on the medical group information, and the request may be submitted electronically or otherwise to the payment authority. In the case of Medicaid, this aspect of enrollment is combined with the request for approval for a provider at one or more facilities, as discussed below with reference to both the request operation 135, and the request operation 165.

At this point, the operational flow of this example may implement alternative directions. According to one embodiment, it may be desirable to request that the provider be approved for billing for only the facility of a current assignment, and in that case operational flow proceeds to the operations of FIG. 5B. However, as an alternative, it may be desirable at the time of initial enrollment to request that the provider be approved for billing at every facility of every HCO that is a member of the medical group 40. This alternative flow is illustrated by the dashed lines where the computing device generates a request for submission to the payment authority for approval for all of the facility IDs of all of the member HCOs at a request operation 135. The request may be submitted electronically or otherwise. In the case of Medicaid, this submission is repeated for each facility in order to enroll the provider at each facility individually, where a unique provider number for each facility for this provider is then assigned by Medicaid.

As shown in FIG. 5B, the computing system also manages the relationship of the member HCO to the temporary healthcare provider. Initially, the member HCO submits a request for an assignment of a temporary healthcare provider to a particular facility of the HCO at a request operation 140. As one example, the request from the HCO may identify the particular provider desired for the assignment. As another example, the request from the HCO may instead trigger the computing system to make a determination of an appropriate healthcare provider. Factors of the request that may determine the temporary provider include the particular location of the facility, the type of services required, whether the provider has been assigned to the HCO for prior assignments, and whether the provider has been assigned to the facility of the HCO for prior assignments.

The computing system matches a temporary healthcare provider to the request by the HCO at a matching operation 145. As noted above, in this example the match may be based on a particular temporary provided requested by the HCO or based on criteria specified by the HCO that the computing system utilizes to identify a particular temporary provider.

The computing system then detects whether the temporary provide who has been matched to the HCO request is a first time match to this HCO at a query operation 150. If this is not the first match of this provider to this HCO, then the computing system may then proceed to wait for the HCO to provide billing information upon completion of the assignment by the provider for the alternative where providers have been approved for all facilities of all HCOs upon enrollment. For the other alternative regarding approval for facilities, if this is not the first match of this provider to this HCO then the computing system may then proceed to a query operation 160 where it is determined if this provider has already been approved for this facility of this HCO, such as because of a prior assignment at this facility. If there has been no approval for this provider for this facility of the current assignment request, then the computing system generates a request for approval of this provider for this facility of the current assignment at a request operation 165, where the request may then be submitted electronically or otherwise to the payment authority. In the case of Medicaid, this submission serves to enroll the provider at each facility individually, where a unique provider number for each of those facilities for this provider is then assigned by Medicaid.

If back at query operation 150 it is determined that this is the first match of this provider to this HCO, then the computing system may then present an assignment agreement to the temporary provider at a presentation operation 155. As discussed above, an example of this assignment agreement is shown in FIG. 3. The executed assignment agreement is received by the computing system from the temporary provider, and then the operational flow of this example may take different paths depending upon the alternative with respect to the facility ID approval. In one path, the computing device then waits for the HCO to provide billing information upon completion of the assignment by the provider for the alternative where providers have been approved for all facilities of all HCOs upon enrollment. In the other path where the facility ID approval occurs only upon an assignment at that facility, operational flow proceeds to the query operation 160 as discussed above.

As yet another alternative, the assignment agreement may provide a blanket assignment to all present and future member HCOs of the medical group. In such a case, the assignment procedure of presentation operation 155 may instead be provided during the initial credentialing and enrollment of the provider with the medical group and the payment authority, such as during the credentialing operation 130 or the enrollment operation 132.

Either path of operational flow eventually returns to a billing operation 170. Here, the computing device receives billing information about the assignment of the temporary provider from the HCO who requested the assignment. Operational flow then proceeds to FIG. 5C, where the computing system then manages the billing, collections, allocations, and distributions.

At a submission operation 175, the computing system submits a bill to the payment authority. This submission includes the billing information provided by the HCO, such as the code for each task done by the temporary provider. The submission also includes any proof of enrollment that may be required by the payment authority, such as the group number assigned by Medicare to the medical group, the provider ID or other number, the facility ID, and so forth. In the case of Medicaid, the submission includes the provider number assigned to this provider for the facility where this work was completed.

Eventually, the computing system receives an acknowledgement of payment being made by the payment authority, such as an electronic payment confirmation. The computing system then allocates the amount owed to the member HCO that owns the facility and submitted the billing information at an allocation operation 180. As discussed above, the allocation is determined by reducing the collected amount by the share of expenses and any hold backs.

The computer system then completes a distribution of the allocated amount to the member HCO that owns the facility, such as by an electronic payment, at a distribution operation 185.

The above example illustrates that when a new HCO is added to the group, existing providers are eligible to work for the new HCO and the work will be billable to the payment authority merely upon approval to bill to the facility IDs of the HCO. The above example further illustrates that when a new provider is enrolled with the group, that provider is then subsequently eligible to work for any member HCO and the work will be billable to the payment authority, in some cases without requiring any further processing.

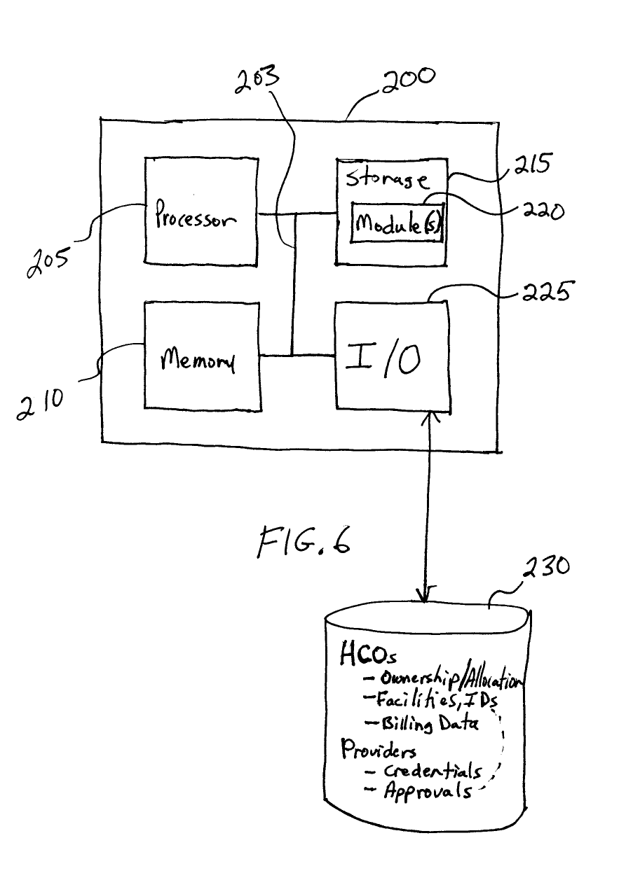

FIG. 6 shows an example of the computing system discussed above. The computing system discussed above may also comprise multiple computing systems 200 such as the example shown in FIG. 6. This illustrative computing system 200, such as a computing system utilized by the management company 50 or the medical group 40, may include various features. A processor 205 may implement programming to provide the operations discussed above. The processor 205 may rely upon a memory 210 to implement the operations. A storage device 215 containing one or more programming modules 220 is accessible by the processor 205 to implement the operations. Furthermore, the processor 205 may interact with users and other computing systems via input/output (I/O) interfaces 225 including displays, network interfaces, and user interface devices.

The computing system 200 also includes a database 230. This database 230 may track the member HCOs 20 of the medical group 40, their ownership percentage, their allocation amounts, their facility information including facility IDs obtained from other sources, and any billing data received from the HCOs. This database 230 may also track the enrolled providers of the medical group 40 including their credentials, such as those discussed above in relation to FIG. 4, as well as any approvals that have been obtained for the providers, such as approvals for one or more facilities of the member HCOs. The database 230 may be saved within a storage device such as the storage device 215 or may be maintained by a separate computing system that is accessed via the interface 225 of the computing system 200 of FIG. 6.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of billing for work done by non-replacement temporary healthcare providers that have assigned their rights to collect on the billing, comprising:
receiving at a computing system electronic information about a healthcare group that utilizes the non-replacement temporary healthcare providers, the information about the healthcare group being necessary for billing for work done on behalf of the healthcare group with a payment authority;
receiving at the computing system electronic information about a non-replacement temporary healthcare provider necessary for enrollment to bill for work to be done by the non-replacement temporary healthcare provider with the payment authority;
receiving at the computing system electronic information regarding the work done by the non-replacement temporary healthcare provider on behalf of the healthcare group; and
generating at the computing system electronic billing information for submission to the payment authority, the electronic billing information comprising at least some of the electronic information received about the healthcare group and at least some of the electronic information received about the non-replacement temporary healthcare provider.

2. The method of claim 1, wherein the healthcare group comprises a plurality of individual healthcare organizations who have contracted for combined ownership of the healthcare group without fee splitting and where the non-replacement temporary healthcare providers have assigned their right to bill for work done to at least one of the healthcare organizations having ownership in the healthcare group, and wherein the method further comprises receiving at the computing system electronic information that is unique to each individual healthcare organization and wherein the electronic billing information further comprises at least some of the electronic information that is unique to the individual healthcare organization where the non-replacement temporary healthcare provider completed the work being billed.

3. The method of claim 2, further comprising allocating at the computing system an amount of payment to be made to the individual healthcare organization where the non-replacement temporary healthcare provider completed the work being billed.

4. The method of claim 3, further comprising receiving a payment from the payment authority for an amount electronically billed to the payment authority on behalf of the healthcare group and distributing from the received payment the amount of payment that has been allocated to the individual healthcare organization.

5. The method of claim 2, wherein the electronic information that is unique to the individual healthcare organization where the non-replacement temporary healthcare provider completed the work being billed comprises a facility identifier.

6. The method of claim 1, further comprising enrolling the healthcare group and the healthcare provider with the payment authority.

7. A method of billing for work done by non-replacement temporary healthcare providers for individual healthcare organizations, wherein a healthcare group comprises a plurality of the individual healthcare organizations who have contracted for combined ownership of the healthcare group without fee splitting, the method comprising:
enrolling the healthcare group with a payment authority responsible for paying for the work done by the non-replacement temporary healthcare providers;
enrolling a non-replacement temporary healthcare provider with the payment authority;
at a computing system, accessing a facility identifier for a facility of an individual healthcare organization where the non-replacement temporary healthcare provider will complete the work;
requesting an approval of the facility identifier from the payment authority for the healthcare group;
receiving at the computing system electronic information regarding the work done by the non-replacement temporary healthcare provider on behalf of the healthcare group at the facility of the individual healthcare organization; and
at the computing system, generating billing information for submission to the payment authority, the billing information comprising the information regarding the work done, information identifying the enrollment of the healthcare group, information identifying the enrollment of the non-replacement temporary provider, and the facility identifier.

8. The method of claim 7, further comprising:
receiving at the computing system electronic information about the healthcare group that is necessary for the billing the payment authority; and
receiving at the computing system electronic information about the non-replacement temporary healthcare provider necessary for enrollment with the payment authority.

9. The method of claim 7, further comprising:
allocating at the computing system an amount of payment to be made to the individual healthcare organization owning the facility where the non-replacement temporary healthcare provider completed the work being billed.

10. The method of claim 7, further comprising receiving a payment from the payment authority for an amount electronically billed to the payment authority on behalf of the healthcare group and distributing from the received payment the amount of payment that has been allocated to the individual healthcare organization.

11. The method of claim 7, further comprising, after enrolling the healthcare group with the payment authority and prior to generating billing information for work done by the non-replacement temporary healthcare provider at the facility of the healthcare organization, receiving at the computing system a submission by the healthcare organization to join the healthcare group.

12. The method of claim 7, further comprising:
enrolling a second non-replacement temporary healthcare provider with the payment authority;
at a computing system, accessing a second facility identifier for a facility of a second individual healthcare organization where the second non-replacement temporary healthcare provider will complete the work;
requesting an approval of the second facility identifier from the payment authority for the healthcare group;
receiving at the computing system electronic information regarding the work done by the second non-replacement temporary healthcare provider on behalf of the healthcare group at the facility of the second individual healthcare organization; and
at the computing system, generating billing information for submission to the payment authority, the billing information comprising the information regarding the work done by the second non-replacement temporary healthcare provider, information identifying the enrollment of the healthcare group, information identifying the enrollment of the second non-replacement temporary provider, and the second facility identifier.

13. The method of claim 12, further comprising:
receiving at the computing system electronic information regarding work done by the non-replacement temporary healthcare provider on behalf of the healthcare group at the facility of the second individual healthcare organization; and
at the computing system, generating billing information for submission to the payment authority, the billing information comprising the information regarding the work done by the non-replacement temporary healthcare provider, information identifying the enrollment of the healthcare group, information identifying the enrollment of the second non-replacement temporary provider, and the second facility identifier.

14. The method of claim 7, further comprising:
enrolling a second individual healthcare organization with the healthcare group;
at a computing system, accessing a second facility identifier for a facility of the second individual healthcare organization where the non-replacement temporary healthcare provider will complete the work;
requesting an approval of the second facility identifier from the payment authority for the healthcare group;
receiving at the computing system electronic information regarding the work done by the non-replacement temporary healthcare provider on behalf of the healthcare group at the facility of the second individual healthcare organization; and
at the computing system, generating billing information for submission to the payment authority, the billing information comprising the information regarding the work done by the non-replacement temporary healthcare provider, information identifying the enrollment of the healthcare group, information identifying the enrollment of the second non-replacement temporary provider, and the second facility identifier.

15. The method of claim 7, further comprising:
enrolling a second non-replacement temporary healthcare provider with the payment authority;
receiving at the computing system electronic information regarding the work done by the second non-replacement temporary healthcare provider on behalf of the healthcare group at the facility of the individual healthcare organization; and
at the computing system, generating billing information for submission to the payment authority, the billing information comprising the information regarding the work done by the second non-replacement temporary healthcare provider, information identifying the enrollment of the healthcare group, information identifying the enrollment of the second non-replacement temporary provider, and the facility identifier.

16. A computing system, comprising:
a database storing information that associates a healthcare group with non-replacement temporary healthcare providers, and associates facility identifiers to individual non-replacement temporary healthcare providers to identify the facilities for which a non-replacement temporary healthcare provider is approved for billing on behalf of the healthcare group to a payment authority, where the facilities are owned by individual healthcare organizations who share ownership of the healthcare group without fee splitting; and
a module that is configured to:
receive electronic information about the non-replacement temporary healthcare providers and store the electronic information to the database,
obtain from the database a non-replacement temporary healthcare provider to work at a facility of a healthcare organization who shares ownership of the healthcare group,
detect from the database whether the non-replacement temporary healthcare provider is approved for billing the payment authority for work done at the facility of the healthcare organization, and
when the non-replacement temporary healthcare provider is not approved for the facility then generates information for submission to the payment authority that requests approval for billing for the work of the non-replacement temporary healthcare provider on behalf of the healthcare group at the facility of the healthcare organization.

17. The computing system of claim 16, wherein the module is further configured to generate billing information for submission to the payment authority, the billing information including an identification of the healthcare group, an identification of the non-replacement temporary healthcare provider, and a facility identifier corresponding to the facility where the work being billed is done.

18. The computing system of claim 17, wherein the module is further configured to allocate an amount of payment from the billing authority to the healthcare group to be provided to the healthcare organization that has the facility where the work that has been billed is done.

19. The computing system of claim 16, wherein the module provides a web based interface to receive the electronic information and the selection.

20. The computing system of claim 16, wherein the module is further configured to receive a submission by the healthcare organization to join the healthcare group.
